(19) United States
(12) Patent Application Publication
(10) Pub. No.: US 2020/0258430 A1
(43) Pub. Date: Aug. 13, 2020

(54) TRACKABLE CUTTING IMPLEMENTS

(71) Applicant: Wolff Industries, Inc., Spartanburg, SC (US)

(72) Inventors: David Wolff, Spartanburg, SC (US); Kalen Caple, Spartanburg, SC (US)

(21) Appl. No.: 16/270,042

(22) Filed: Feb. 7, 2019

(51) Int. Cl. G09F 3/00; B26B 3/00; B24B 3/52; B24B 3/54; A22C 15/00; G09F 3/12; G06K 19/06; G06K 7/14

(52) U.S. Cl. CPC G09F 3/0297; B26B 3/00; B24B 3/52; B24B 3/54; B26B 13/00; G09F 3/12; G06K 19/06037; G06K 7/1417; A22C 15/003

(57) ABSTRACT

Trackable cutting implements are provided. A trackable cutting implement includes a cutting implement, the cutting implement including a plastic body and a cavity defined in the plastic body, the cavity having an opening defined in an outer surface of the plastic body. A trackable cutting implement further includes a tag disposed within the cavity, the tag including a tracking indicium. A trackable cutting implement further includes an epoxy disposed within the cavity and covering the tag, wherein the tracking indicium is visible through the epoxy.

### FIELD

The present disclosure relates generally to cutting implements, and more particularly to improved cutting implements which include tracking components allowing the implements to be easily and efficiently tracked.

### BACKGROUND

Cutting implements, such as knives, scissors, and sharpeners thereof, are utilized in a wide variety of environments for a wide variety of purposes. In addition to personal use, for example, cutting implements are utilized in various commercial settings. One particular setting is the food processing industry, wherein cutting implements are utilized on a daily basis to process various types of food, such as for example poultry.

In such commercial settings, it is vital to track the cutting implements before, during, and after use. Loss and/or theft of cutting implements can be expensive and detrimental not just due to the loss of the cutting implements themselves, but also due to potential shut-down of the commercial operation in an effort to find the cutting implements. Further, in the food processing industry, processed food can go to waste due to the loss of cutting implements because of the associated shut-down and potential violations of food safety regulations.

Accordingly, improved apparatus for tracking cutting implements is desired. In particular, simple, efficient, and inexpensive solutions which facilitate such tracking would be advantageous.

### BRIEF DESCRIPTION

Aspects and advantages of the invention will be set forth in part in the following description, or may be obvious from the description, or may be learned through practice of the invention.

In accordance with one embodiment, a trackable cutting implement is provided. The trackable cutting implement includes a cutting implement, the cutting implement including a plastic body and a cavity defined in the plastic body, the cavity having an opening defined in an outer surface of the plastic body. The trackable cutting implement further includes a tag disposed within the cavity, the tag including a tracking indicium. The trackable cutting implement further includes an epoxy disposed within the cavity and covering the tag, wherein the tracking indicium is visible through the epoxy.

In accordance with another embodiment, a trackable cutting implement is provided. The trackable cutting implement includes a cutting implement, the cutting implement including a plastic body and a cavity defined in the plastic body, the cavity having an opening defined in an outer surface of the plastic body. The trackable cutting implement further includes a metal tag disposed within the cavity, the tag including a tracking indicium, wherein the tag is connected to the plastic body within the cavity. The trackable cutting implement further includes a food-grade epoxy disposed within the cavity and covering the tag, wherein the tracking indicium is visible through the epoxy.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF FIGURES

A full and enabling disclosure of the present invention, including the best mode thereof, directed to one of ordinary skill in the art, is set forth in the specification, which makes reference to the appended figures, in which:

FIG. 1 illustrates a variety of trackable cutting implements in accordance with embodiments of the present disclosure;

FIG. 2 illustrates a portion of a trackable cutting implement, including a plastic body and associated tag and epoxy, in accordance with embodiments of the present disclosure;

FIG. 3 illustrates a portion of a trackable cutting implement, including a plastic body and associated tag and epoxy, in accordance with other embodiments of the present disclosure; and

FIG. 4 is an exploded view of a portion of a trackable cutting implement, including a plastic body and associated tag and epoxy, in accordance with other embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

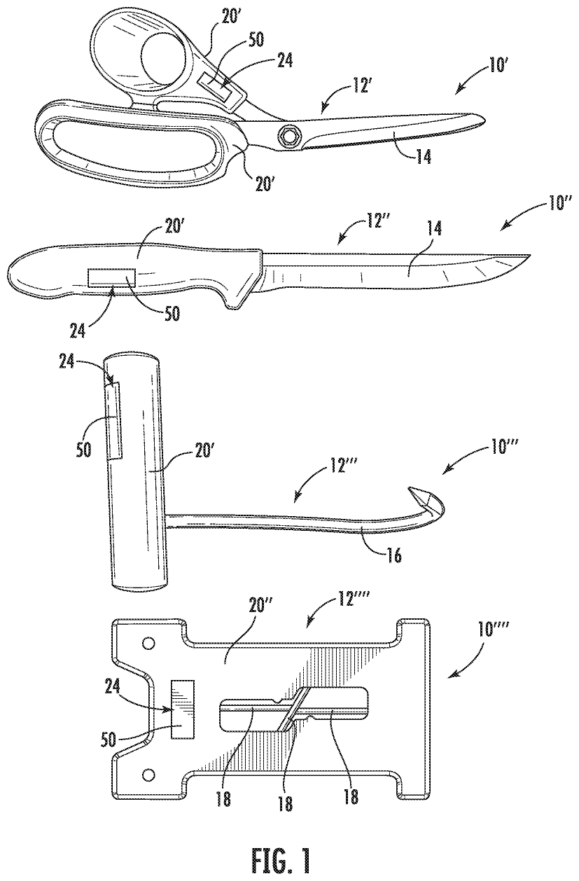

Referring now generally to FIGS. 1 through 4, trackable cutting implements are disclosed. A trackable cutting implement in accordance with the present disclosure advantageously includes an embedded, yet visible, tracking indicium. Embedding of the tracking indicium reduces and/or prevents the risk of the tracking indicium being damaged or dislodged from the cutting implement during use, thus facilitating relatively more reliable tracking of the cutting implement. The visibility of the tracking indicium allows for reliable tracking using efficient and, in some cases relatively inexpensive, tracking apparatus.

In exemplary embodiments, the tracking indicium is a barcode. Suitable barcode types include, for example, UPC barcodes, EAN barcodes, Code 39 barcodes, Code 128 barcodes, ITF barcodes, Code 93 barcodes, Codabar barcodes, GS1 DataBar barcodes, MSI Plessey barcodes, QR codes, Datamatrix codes, PDF417 codes, and/or Aztec codes. Alternatively, however, the tracking indicia need not be a barcode. For example, suitable alphanumeric coding, color-based coding, symbol-based coding, or other visible indicia may be utilized as the tracking indicia in accordance with the present disclosure.

Trackable cutting implements (and the cutting implements thereof) in accordance with the present disclosure may include cutting tools, such as knives, scissors, food processing hooks (e.g. boning hooks) and other tools which include suitable cutting blades and/or penetrating components. Trackable cutting implements (and the cutting implements thereof) may further include sharpeners and other tools utilized in conjunction with such cutting tools.

Referring now to FIG. 1, a variety of trackable cutting implements 10 are illustrated. In particular, scissors 10′, knife 10″, hook 10′″, and sharpener 10″″ are illustrated. Each trackable cutting implement 10 includes a cutting implement 12 and other components as discussed herein to facilitate tracking of the cutting implement. In FIG. 1, the exemplary cutting implements 12 are scissors 12′, knife 12″, hook 12′″, and sharpener 12″″.

The cutting implement 12 may include one or more cutting components, such as one or more blades 14 and/or one or more hooks 16. Additionally or alternatively, the cutting implement 12 may include one or more sharpening members 18.

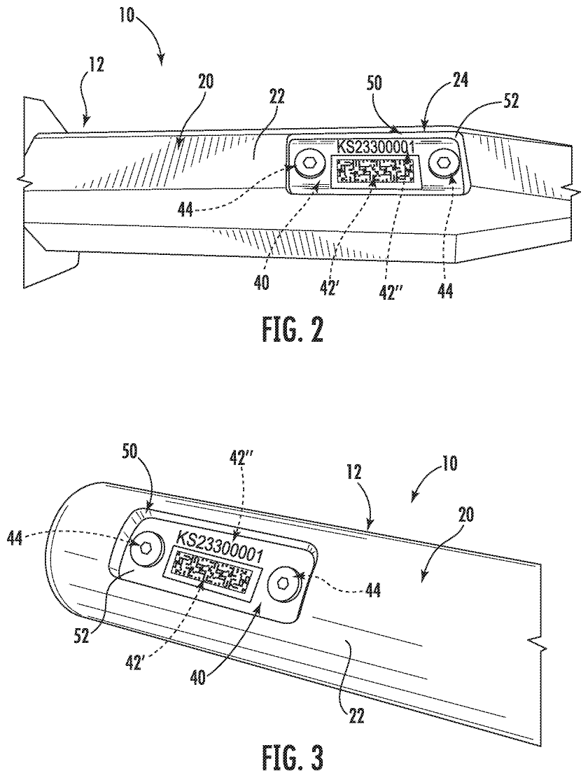

Further, and referring now additionally to FIGS. 2 through 3, a cutting implement 12 may include a plastic body 20. In some embodiments, the plastic body 20 is a handle 20′ from which other components, such as blade(s) 14 and/or hook(s) 16 extend and in which such components are partially embedded. In other embodiments, the plastic body 20 may be a main body 20″ from which other components, such as sharpening members 18, extend and in which such components are partially embedded.

In exemplary embodiments, the plastic body 20 is formed from a thermoplastic, such as in some embodiments a thermoplastic elastomer. Alternatively, other suitable plastics may be utilized. In exemplary embodiments, such plastic is a hard plastic which is generally non-pliable when in a formed or cured state.

The plastic body 20 includes one or more outer surfaces 22, and a cavity 24 is defined in the plastic body 20. The cavity 24 may, for example, be milled into the plastic body 20. The cavity 24 includes an opening 26 which is defined in one of the outer surfaces 22. In some embodiments as shown in FIG. 2, the outer surface 22 is planar. In other embodiments, as shown in FIG. 3, the outer surface 22 is curviplanar. In still other embodiments, the outer surface 22 may have other suitable shapes, including for example partially planar and/or curviplanar shapes.

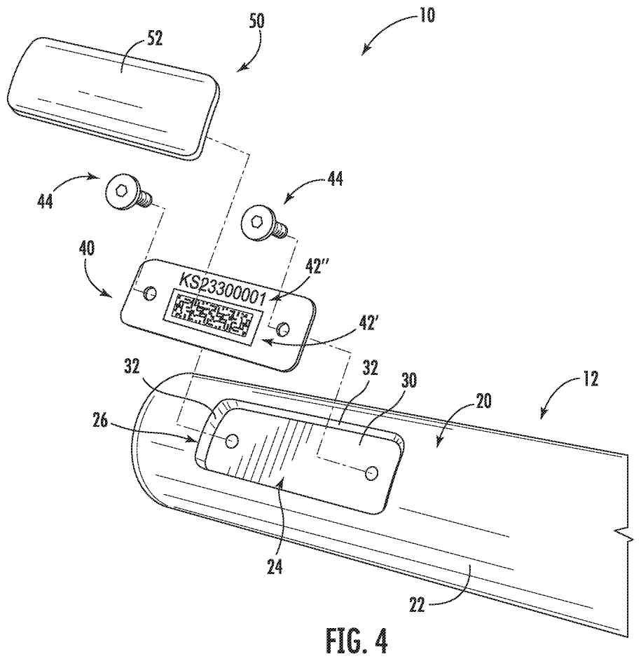

The cavity 24 may have any suitable shape, with such shape being defined by surrounding plastic body inner surfaces. In some embodiments, as illustrated in FIG. 4, the cavity 24 may be defined by a plastic body base surface 30 and/or one or more plastic body side surfaces 32. In some embodiments, the plastic body base surface 30 may be a planar surface, thus allowing a planar tag to be connected to the surface as discussed herein.

As illustrated, a trackable cutting implement 10 may further include a tag 40 which is disposed within the cavity 24. Tag 40 may, for example, be formed from a suitable metal, such as in some embodiments stainless steel. The tag 40 may include one or more tracking indicia 42. For example, the tag 40 shown in FIGS. 2 through 4 includes two distinct tracking indicia 42, a first tracking indicium 42′ and a second tracking indicium 42″. In some embodiments, such as in the case of the illustrated first tracking indicium 42′, a tracking indicium 42 may be a barcode, such as datamatrix code or other suitable barcode as discussed. In additional or alternative embodiments, such as in the case of the illustrated second tracking indicium 42″, a tracking indicium 42 may be an alphanumeric code. The tracking indicium 42 utilized on a tag 42 is in exemplary embodiments a distinct indicium which allows the trackable cutting implement 10 to be distinguished via the indicium from other such trackable cutting implements.

In some embodiments, the tag 40 may be in contact with and connected to the plastic body 20 within the cavity 24, such as to a plastic body surface defining the cavity 24. For example, the tag 40 may be in contact with and connected to the plastic body base surface 30. In some embodiments, as shown, one or more screws 44 may be utilized to connect the tag 40 to such surface, e.g., by extending through the tag 40 and into the plastic body 20. Alternatively, other suitable mechanical fasteners, an adhesive, or another suitable connecting apparatus may be utilized.

In alternative embodiments, the tag 40 need not be in contact with or connected to the plastic body 20 within the cavity 24. For example, in some embodiments, the tag 40 may be spaced from the plastic body 20 within the cavity 24, and may “float” in the cavity 24 supported by, for example, an epoxy as discussed herein.

As further illustrated, an epoxy 50 may be disposed within the cavity 24. Epoxy 50 generally covers the tag 40, and may further generally fill the cavity 24. For example, the epoxy 50 may cover the tag 40 which is connected to the plastic body 20 such that the tag 40 is partially embedded in the epoxy 50, or may completely cover the tag 40 such that the tag 40 is fully embedded in the epoxy 50 and floats in the cavity 24.

The tracking indicia 42 (and the tag 40 itself) may advantageously be visible through the epoxy 50. Accordingly, the epoxy 50 may be translucent or transparent. Such visibility allows a user to view the tracking indicia 42 and further allows tracking apparatus, such as barcode readers, to read the tracking indicia 42 through the epoxy 50. In exemplary embodiments, the epoxy 50 is a food grade-epoxy (e.g. a food safe epoxy), thus meeting suitable USDA food-grade standards.

As discussed, the epoxy 50 is disposed with the cavity 24, and may generally fill the cavity 24. Further epoxy 50 may include an outer surface 52. Outer surface 52 may be disposed at or extend through opening 26. Further, in some embodiments, the outer surface 52 may correspond with the outer surface 22 in which the opening 26 is defined. Thus, the outer surface 52 may be considered as a portion of the outer surface 22. For example, in embodiments wherein the outer surface 22 is planar, the outer surface 52 may be correspondingly planar. In embodiments wherein the outer surface 22 is curviplanar, the outer surface 52 may be correspondingly curviplanar. Accordingly, no significant disruptions may be evident in the surface contour of the outer surface 22 of the trackable cutting implement 10 due to the cavity 24, opening 26, and epoxy 50.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A trackable cutting implement, comprising:
a cutting implement, the cutting implement comprising a plastic body and a cavity defined in the plastic body, the cavity having an opening defined in an outer surface of the plastic body;
a tag disposed within the cavity, the tag comprising a tracking indicium; and
an epoxy disposed within the cavity and covering the tag, wherein the tracking indicium is visible through the epoxy.

2. The trackable cutting implement of claim 1, wherein the tracking indicium is a barcode.

3. The trackable cutting implement of claim 2, wherein the barcode is a datamatrix code.

4. The trackable cutting implement of claim 1, wherein the cavity is defined by a plastic body base surface and at least one plastic body side surface.

5. The trackable cutting implement of claim 4, wherein the tag is connected to the plastic body base surface.

6. The trackable cutting implement of claim 1, wherein the tag is connected to the plastic body within the cavity.

7. The trackable cutting implement of claim 6, further comprising a screw connecting the tag to the plastic body within the cavity.

8. The trackable cutting implement of claim 1, wherein the plastic body is formed from a thermoplastic elastomer.

9. The trackable cutting implement of claim 1, wherein the tag is formed from a metal.

10. The trackable cutting implement of claim 9, wherein the metal is stainless steel.

11. The trackable cutting implement of claim 1, wherein the epoxy is a food-grade epoxy.

12. The trackable cutting implement of claim 1, wherein an outer surface of the epoxy corresponds with the outer surface of the plastic body.

13. The trackable cutting implement of claim 1, wherein the cutting implement is a knife and the plastic body is a handle of the knife.

14. The trackable cutting implement of claim 1, wherein the cutting implement is a sharpener and the plastic body is a main body of the sharpener.

15. A trackable cutting implement, comprising:
a cutting implement, the cutting implement comprising a plastic body and a cavity defined in the plastic body, the cavity having an opening defined in an outer surface of the plastic body;
a metal tag disposed within the cavity, the tag comprising a tracking indicium, wherein the tag is connected to the plastic body within the cavity; and
a food-grade epoxy disposed within the cavity and covering the tag, wherein the tracking indicium is visible through the epoxy.

16. The trackable cutting implement of claim 15, wherein the tracking indicium is a barcode.

17. The trackable cutting implement of claim 15, wherein the cavity is defined by a plastic body base surface and at least one plastic body side surface, and wherein the tag is connected to the plastic body base surface.

18. The trackable cutting implement of claim 15, further comprising a screw connecting the tag to the plastic body within the cavity.

19. The trackable cutting implement of claim 15, wherein the plastic body is formed from a thermoplastic elastomer.

20. The trackable cutting implement of claim 15, wherein an outer surface of the epoxy corresponds with the outer surface of the plastic body.
